(19) United States
(12) Patent Application Publication
(10) Pub. No.: US 2026/0084102 A1
(43) Pub. Date: Mar. 26, 2026

(54) ATMOSPHERIC WATER GENERATION SYSTEM AND METHOD

(71) Applicant: Water From Air, Inc., Pasadena, CA (US)

(72) Inventors: Andrea Pedretti, Thousand Oaks, CA (US); William Tod Gross, Pasadena, CA (US)

(21) Appl. No.: 19/108,117

(22) PCT Filed: Aug. 30, 2023
(86) PCT No.: PCT/US2023/031550

§ 371 Date: Feb. 28, 2025

Related U.S. Application Data
(60) Provisional application No. 63/374,510, filed on Sep. 2, 2022.

(51) Int. Cl. B01D 53/26; E03B 3/28

(52) U.S. Cl. CPC B01D 53/261; B01D 53/265; E03B 3/28

(57) ABSTRACT

Methods and systems are disclosed for atmospheric water generation. Airflow is directed through a volume of adsorbent material, the adsorbent material configured to capture water in the airflow. A heater heats the adsorbent material via conduction heat transfer to effect a desorption process to release the moisture from the adsorbent material as steam. The steam flows to a condenser that condenses the steam into liquid water, which is collected. Heat released by the condensation of the steam is at least partially recovered and directed to the heater that heats the adsorbent material.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to systems and methods for atmospheric water generation, and more particularly to an improved atmospheric water generation system and method with heat recovery.

### Description of the Related Art

Existing systems for generating water from the atmosphere, such as via radiative cooling or condensers, are undesirable because they require a lot of electricity to operate. Additionally, such existing systems may work well in high humidity environments where the air has a high relative humidity, but do not work well in lower humidity environments as the dew point is much lower than ambient temperature. Other systems for generating water utilize a desiccant material that adsorbs water from air (e.g., like a sponge) and from which water can be obtained by blowing heated air through the desiccant material. However, such systems are also undesirable because not only does blowing hot air through the desiccant material inefficiently heat the desiccant material but also removes humidity from the desiccant material that can then not be recovered as water. Additionally, existing systems discussed above require that all the air volume in the system be heated or cooled down to generate water, which requires a lot of energy (e.g., electricity) to accomplish.

### SUMMARY

In accordance with one aspect of the disclosure, an improved system and method for atmospheric water generation is provided that does not require cooling all of a volume of air to generate water, and therefore requires less energy.

In accordance with another aspect of the disclosure, a system for atmospheric water generation includes a volume of adsorbent material, through which airflow is directed, the adsorbent material configured to capture water in the airflow that condenses thereon. The system also includes a heater that directly heats the adsorbent material via direct contact (e.g., via conduction heat transfer) to effect a desorption process (e.g., evaporation process) to release the moisture from the adsorbent material as steam of very high relative humidity level. The system also includes a condenser through which the steam flows. Water in the steam flow is condensed by the condenser and collected. Heat released by the steam flow passing through the condenser is at least partially recovered and directed to the heater that directly heats the adsorbent material.

In accordance with another aspect of the disclosure, a method for generating water from the atmosphere is provided. The method includes the step of flowing air though an adsorbent material so that water condenses out of the air onto the adsorbent material. The method also includes the step of directly heating via contact (e.g., via conduction heat transfer) the adsorbent material with a heater to desorb (e.g., evaporate) the water from the adsorbent material as steam. The method also includes the step of flowing the steam through a condenser to condense and collect the water from the steam. The method further includes the step of recovering at least a portion of the heat released by the condensation of water from steam and directing said heat to the heater that directly heats the adsorbent material.

In accordance with another aspect of the disclosure, a multistage atmospheric water generation system is provided. The system includes multiple heat exchange modules. Each heat exchange module houses a tube and fin heat exchanger and adsorbent material (e.g., desiccant material) in direct contact with the heat exchanger, and has a water inlet, a water outlet and a steam outlet. The heat exchange modules are stationary and arranged about a rotatable manifold that functions as a rotary valve that routes heated water through the heat exchange modules to generate steam at different temperatures via desorption of water from the adsorbent material, the steam directed to a condenser unit in the manifold. The system recovers latent heat of condensation from condensing steam from one heat exchange module to pre-heat or heat water flowing into another heat exchange module. The system also recovers sensible heat from the adsorbent material to cool the adsorbent material and transfer heat to the water that flows through the heat exchangers.

In accordance with another aspect of the disclosure, a multistage atmospheric water generation system is provided. The system includes a stator with multiple recesses housing a heater and a rotor that is rotatably coupled to the stator and has adsorbent material (e.g., desiccant material, silica gel) in separate recesses thereof. Heated water flows through the stator to heat the adsorbent material at different temperatures via conduction heat transfer with the heater in respective recesses to generate steam different temperatures via desorption of water from the adsorbent material. The steam generated in one stage is recovered and used to preheat water flowing into a previous stage during the desorption process. The system also recovers sensible heat from the adsorbent material to cool the adsorbent material and transfer heat to said water that flows through the stator.

In some aspects, the techniques described herein relate to an atmospheric water generation system, including: a volume of adsorbent material configured to receive airflow therethrough in an adsorption mode of operation, the adsorbent material configured to capture water in the airflow that condenses on the adsorbent material; a heater in thermal contact with the adsorbent material and configured to heat the adsorbent material via conduction heat transfer in a desorption mode of operation to effect a desorption of moisture from the adsorbent material as steam; and a condenser that receives and condenses the steam into liquid water, wherein heat is released by the condensation of the steam, at least a portion of said heat being recovered and directed to the heater.

In some aspects, the techniques described herein relate to a method of generating atmospheric water, including: flowing air through an adsorbent material in an adsorption stage so that water condenses from the air onto the adsorbent material; heating the adsorbent material with a heater via conduction heat transfer in a desorption stage to desorb the water from the adsorbent material as steam; flowing the steam to a condenser configured to condense the steam into liquid water; and recovering at least a portion of heat released by the condensation of the steam and directing said recovered heat to the heater.

In some aspects, the techniques described herein relate to an atmospheric water generation system, including: multiple heat exchange modules, each heat exchange module including a container housing a tube and fin heat exchanger, a volume of adsorbent material in thermal contact with the tube and fin heat exchanger, a water inlet in fluid communication with one end of the tube, a water outlet in fluid communication with another end of the tube, and a steam outlet; a rotatable manifold about which the multiple heat exchange modules are arranged, the rotatable manifold configured to route heated water through the heat exchange modules to generate steam at different temperatures via desorption of water from the adsorbent material; a condenser configured to condense said steam generated at the different temperatures into liquid water, wherein heat from condensing steam generated in one heat exchange module is recovered and directed to another heat exchange module to heat water flowing into the water inlet of another heat exchange module.

In some aspects, the techniques described herein relate to an atmospheric water generation system, including: a stator including a plurality of recesses circumferentially arranged about an axis, the plurality of recesses housing a plurality of heaters; a rotor including a plurality of recesses circumferentially arranged about a second axis, the plurality of recesses of the rotor housing a plurality of volumes of adsorbent material, the rotor configured to rotatably couple to the stator and configured to rotate relative to the stator about the second axis to place one heater in thermal contact with one volume of adsorbent material to heat said one volume of adsorbent material via conduction heat transfer to desorb water from the adsorbent material as steam, said plurality of heaters and said plurality of volumes of adsorbent material providing multiple modules, each module operable to generate steam at a different temperature; and a condenser configured to condense said steam generated at the different temperatures into liquid water, wherein heat from condensing steam generated in one module is recovered and directed to a heater in another module to heat water flowing into said heater of another module.

### BRIEF DESCRIPTION OF THE DRAWINGS

FIG. 1 is a schematic view of a portion of a system for atmospheric water generation.

FIG. 2 is a schematic view of a portion of a system for atmospheric water generation.

FIG. 3 is a schematic top view of a system for atmospheric water generation.

FIG. 4 is an exploded schematic view of the system in FIG. 3.

FIG. 5 is a schematic cross-sectional view of a portion of the system in

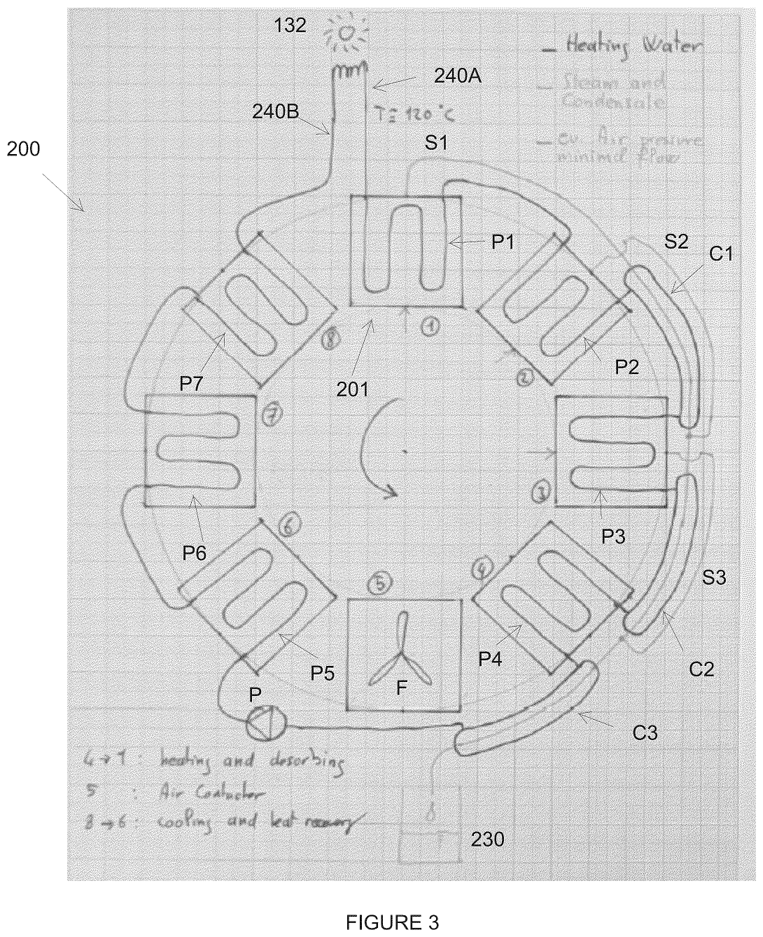

FIG. 3.

FIG. 6 is a schematic cross-sectional view of the system in FIG. 3.

FIG. 7 is a schematic perspective view of a heat exchange module for a system for atmospheric water generation.

FIG. 8 is a schematic perspective view of a manifold for a system for atmospheric water generation.

FIG. 9 is a top view of the manifold in FIG. 8.

FIG. 10 is a schematic top view of a system for atmospheric water generation with the manifold of FIG. 8 and the heat exchange module of FIG. 7.

FIG. 11 is a schematic side view of a condenser unit in the system of FIG. 10.

FIG. 12 is a schematic view of a system for atmospheric water generation.

FIG. 13 is a schematic view of a concentrated solar power system.

### DETAILED DESCRIPTION

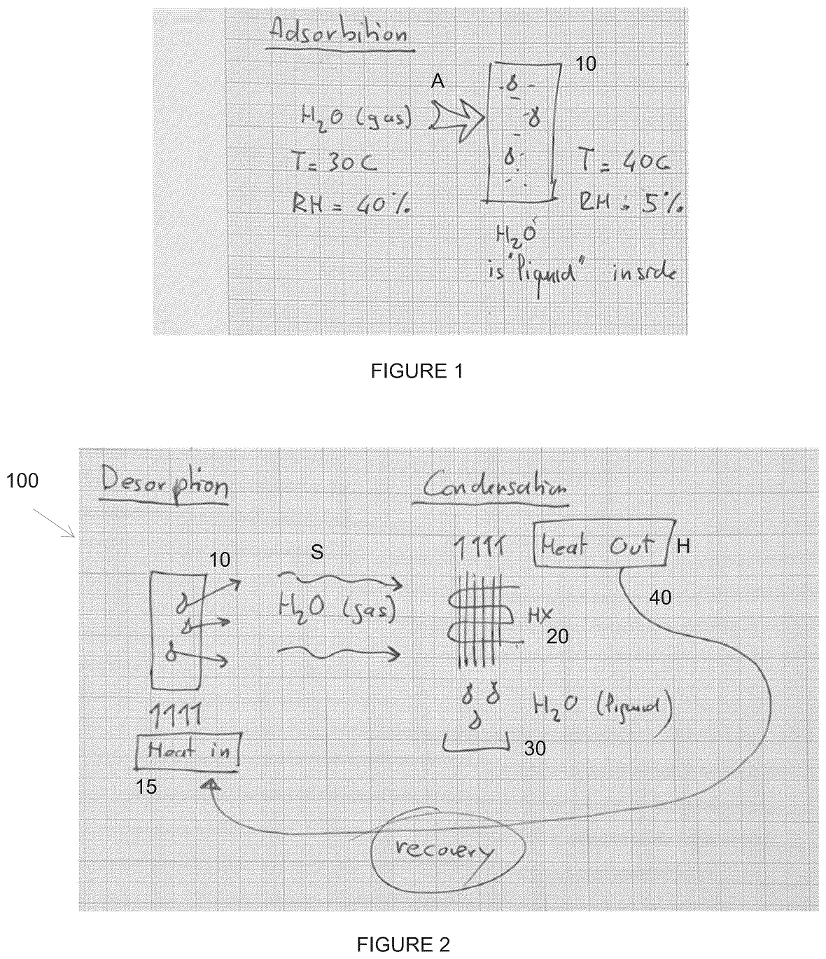

FIGS. 1-2 show a system 100 for atmospheric water generation. The system 100 includes a volume of adsorbent material 10. In one implementation, the adsorbent material 10 is a solid adsorbent material. In another implementation, the adsorbent material is a liquid adsorbent material (e.g., lithium bromide, lithium chloride, calcium chloride, glycols, etc.). The adsorbent material 10 can be a desiccant material. In one example, the adsorbent material 10 can be silica gel (e.g., the volume of adsorbent material 10 can be a volume of silica gel beads). In another example, the adsorbent material 10 can be a molecular sieve, such as Zeolite, aluminum phosphate or a metal-organic framework. Airflow A can be directed through the volume of adsorbent material 10 (e.g., via forced flow, such as with a fan) so that water condenses from the airflow onto the adsorbent material 10.

FIG. 1 shows an adsorption step in the atmospheric water generation process. In one example, airflow A at a temperature of 30° C. and at 40% relative humidity can pass through the volume of adsorbent material 10. The airflow A can exit the volume of adsorbent material 10 at a higher temperature (e.g., 40° C.) and lower relative humidity (e.g., 5%).

FIG. 2 shows a desorption step and condensation step in the atmospheric water generation process using the system 100. The system 100 includes a heater 15 in direct contact with the volume of adsorbent material 10 that transfers heat thereto (e.g., via conduction heat transfer) to desorb the water from the adsorbent material 10 (e.g., cause the water to evaporate) as steam S. The system 100 includes a heat exchanger or condenser 20 the steam S passes through or over, causing water to condense from the steam S, which is collected in a receptacle 30. The condensation of water from the steam S releases heat H that is recovered, at least a portion of which is directed to the heater 15 and used to pre-heat or heat the volume adsorbent material 10 (e.g., in a next or subsequent desorption step). In one implementation, said heat H released by the condensation of steam S heats water in a pipe 40, the pipe 40 extending to or at least partially defining the heater 15 that is in direct contact with and directly heats (e.g., via conduction heat transfer) the volume of adsorbent material 10. In one implementation, the heater 15 is defined by the water pipe 40 and extends through the volume of adsorbent material 10. Optionally, fins can extend from the water pipe and be in direct contact with the adsorbent material 10.

Advantageously, heating the volume of adsorbent material 10 via direct contact (e.g., via conduction heat transfer) with the heater 15 is much more efficient than heating the adsorbent material 10 via convection (e.g., by blowing heated air through the volume of adsorbent material). Additionally, direct contact between the heater 15 (e.g., water pipe 40 as described herein) and the volume adsorbent material 10 allows the system 100 to efficiently recover the sensible heat of the adsorbent material 10 (e.g., via conduction heat transfer from the adsorbent material to the water pipe) to cool the adsorbent material 10 (e.g., to ambient temperature), allowing the adsorbent material 10 to again receive airflow A in an adsorption step to capture water via condensation from the airflow A.

Additionally, pre-heating or heating the volume of adsorbent material 10 allows the steam S generated in the desorption step to be at a higher temperature, and the subsequent condensation of water from steam S via the condenser 20 to be at a higher temperature so that at least a portion of the latent heat of condensation can be recovered and reused in pre-heating or heating the volume of adsorbent material 10 via the heater 15 (e.g., water pipe 40). In one example, where the adsorbent material 10 is silica gel, for each kilogram of silica gel that is fully saturated at normal ambient conditions (e.g., temperature of 30° C., pressure of 1 bar) approximately 200 liters of steam can be obtained at ambient conditions (e.g., temperature of 100° C. and pressure of 1 bar). The system 100 advantageously allows for the recovery of sensible heat from the silica gel and latent heat of condensing the steam S via the condenser 20.

In one implementation, the system 100 can be a single stage system for atmospheric water generation. In other implementations, discussed further below, the system can be a multi-stage system for atmospheric water generation. For example, the system can be a two-stage system. Where the system for atmospheric water generation is a multi-stage system, one or more of the stages can apply vacuum (e.g., apply different amounts of vacuum) to the adsorbent material of said stage(s) to facilitate (e.g., assist) the desorption process for said stage(s) and/or to lower the desorption temperature to facilitate recovering at least a portion of the heat of condensation when condensing the steam for said stage(s). The application of vacuum to the adsorbent material (e.g., lowering the pressure of the adsorbent material) can help the adsorbent material absorb better the water that condenses on it from the airflow.

FIGS. 3-6 show a system 200 for atmospheric water generation having multiple stages 201. In the illustrated implementation, the system 200 has eight stages. However, the system 200 can have more or fewer stages than shown (e.g., 2 stages, 3 stages, 10 stages, etc.).

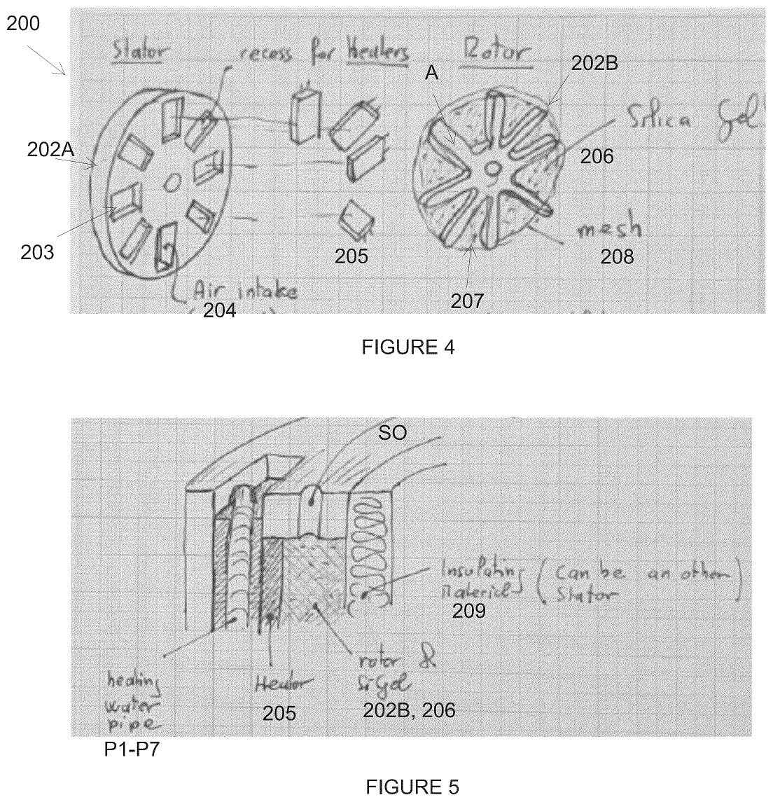

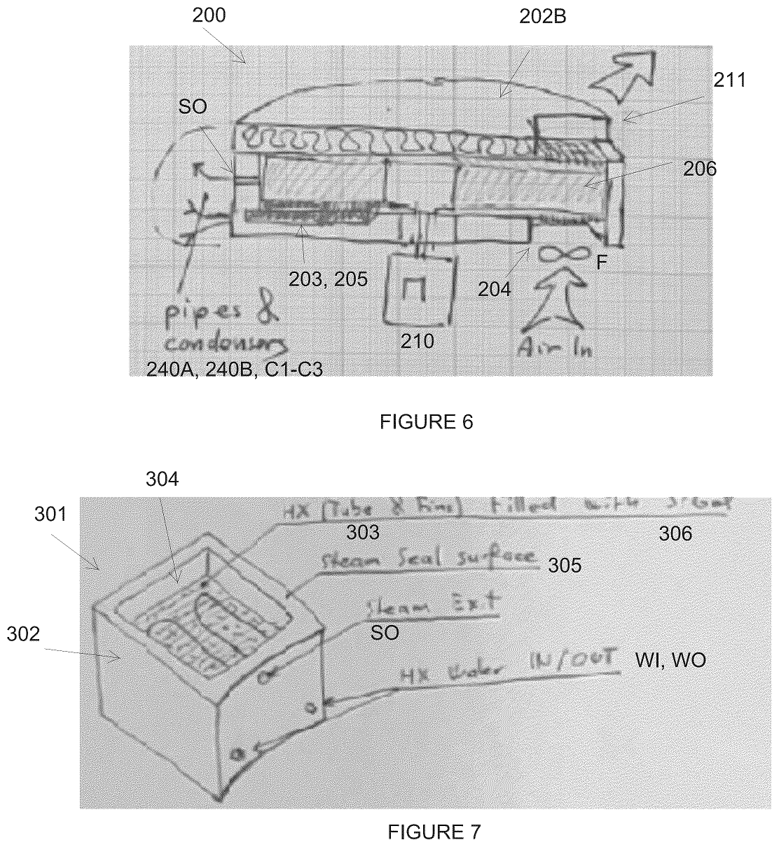

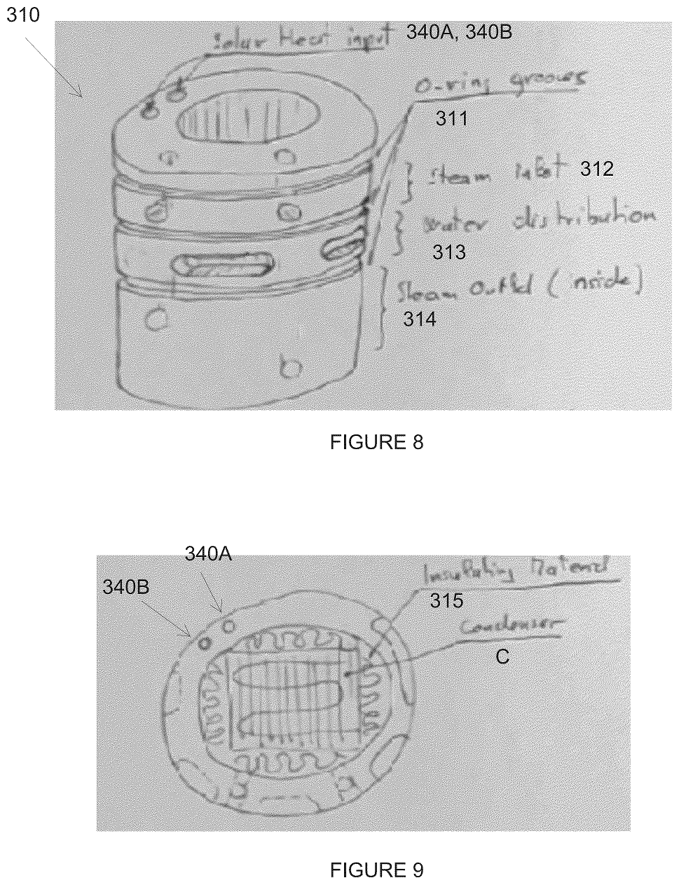

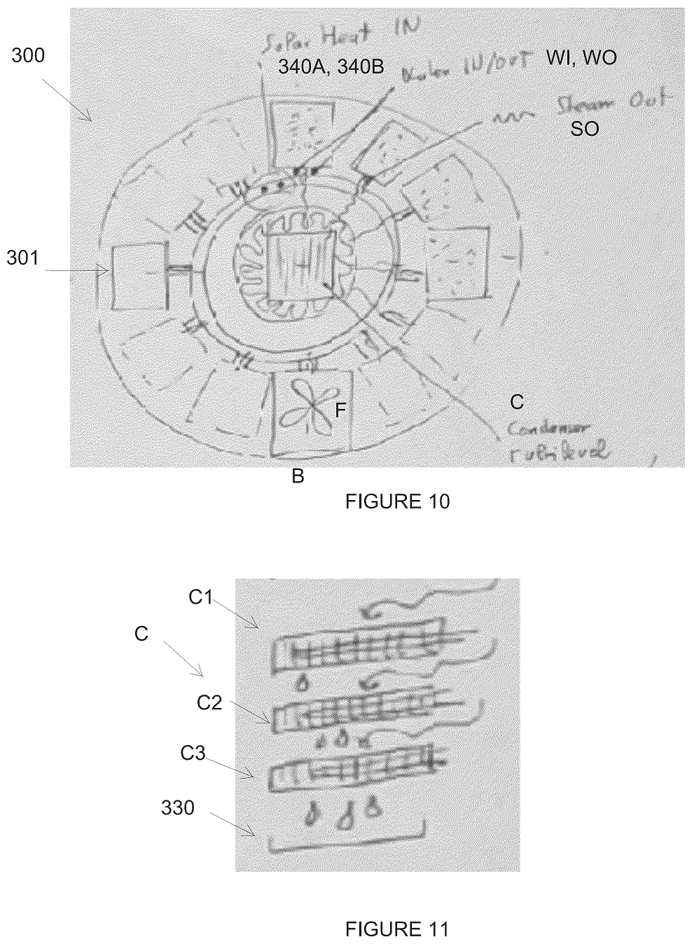

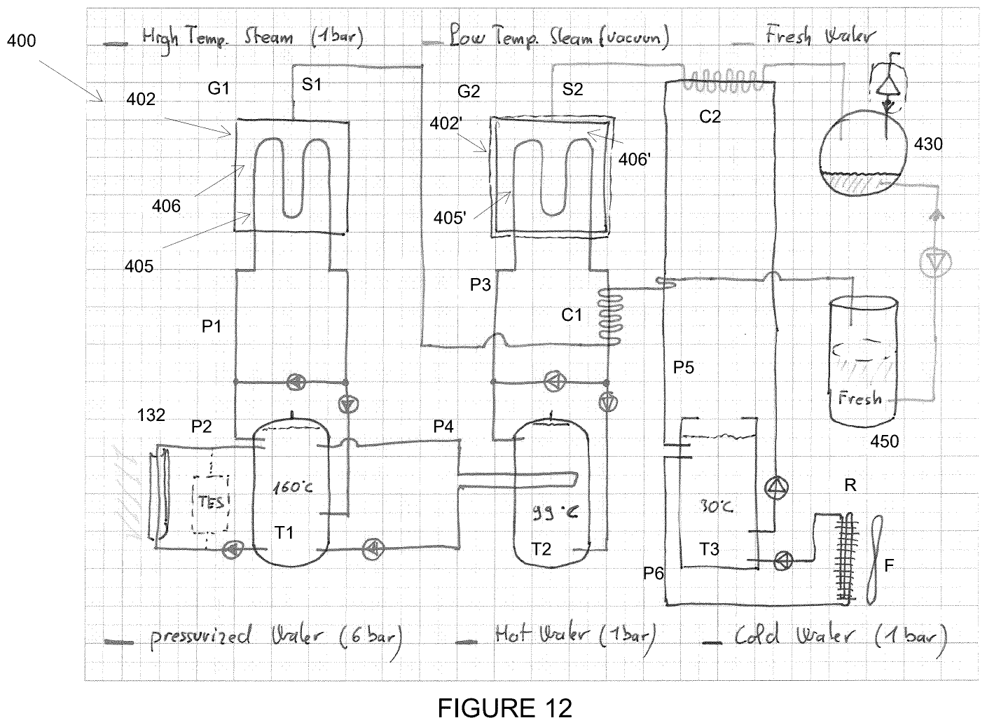

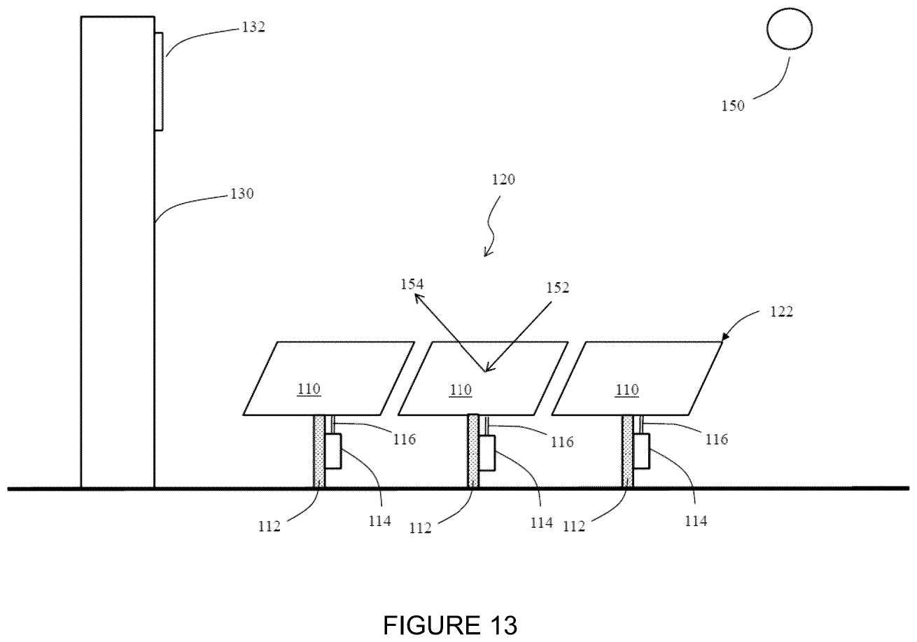

With reference to FIG. 4, the system 200 includes a stator 202A that defines multiple recesses 203, each sized to receive a heater 205. Each heater 205 can include a volume of material with high thermal conductivity. The stator 202A also includes an air intake opening 204. The system 200 also includes a rotor 202B that is rotatably coupled to the stator 202A and can be rotated by an electric motor 210 (see FIG. 6) relative to the stator 202A. The rotor 202B has multiple recesses 207 separated by arms A, where the recesses 207 contain an adsorbent material (e.g., silica gel) 206 that can be retained in the recesses 207 by a mesh 208. The number of recesses 207 on the rotor 202B that contain adsorbent material 206 coincides with the number of recesses 203 and the air intake opening 204 on the stator 202A. In operation, as further discussed below, the rotor 202B is rotated (by the electric motor 210) relative to the stator 202A so that each of the recesses 207 of the rotor 202B aligns with one of the recesses 203 or with the air intake opening 204 of the stator 202A to provide the stages 201 of the system 200. The rotor 202B has an air outlet opening 211 (see FIG. 6) that aligns with the air intake opening 204 on the stator 202A. Airflow that passes through the air intake opening 204 of the stator 202A and passes through the adsorbent material 206 aligned with the air intake opening 204, exits the adsorbent material 206 via the air outlet opening 211. As shown in FIG. 5, an insulating material 209 (e.g., thermally insulating material) can be disposed on an opposite side of the adsorbent material 206 from the heater 205. In one implementation, the insulating material 209 can be part of another stator.

With reference to FIG. 3, the multi-stage atmospheric water generation system 200 operates as discussed below. In the illustrated implementation, the rotor 202B rotates counterclockwise relative to the stator 202A. Water flows through pipes 240A, 240B and pipes P1-P7, which are connected together as shown in the figure, in a clockwise direction in the figure. The pipe 240A is an outflow pipe 240A and the pipe 240B is a return pipe 240B. Accordingly, the system 200 provides a countercurrent or counterflow relationship between the movement of the rotor 202B (e.g., the movement of the adsorbent material 206) and the direction of flow of water through the pipes 240A, 240B, P1-P7, with the pipes P1-P7 arranged in a crossflow manner relative to the adsorbent material 206. In the illustrated implementation, the fifth stage 5 (at the bottom of the figure) is where the adsorption process occurs by flowing air (e.g., with a fan F) through the air intake opening 204, past the adsorbent material 206 (which is at its lowest temperature in the cycle) to collect water from the airflow (via condensation), with the air exiting at a lower relative humidity level via the air outlet opening 211. The first through the fourth stages 1-4 in FIG. 2 is where the desorption process occurs, as discussed further below, and the sixth through eight 6-8 stages in FIG. 2 is where recovery of sensible heat from the adsorbent material 206 occurs, as further discussed below. As discussed above, the multistage system 200 can have any number of stages, so can have fewer or more desorption stages and fewer or more sensible heat recovery stages.

In operation, water flows along the outflow pipe 240A from a heating location, such as a receiver 132 where the water is heated via a solar flux to a first temperature T1. The receiver 132 can be part of a concentrated solar power system, further discussed below (in FIG. 12). In one implementation, the first temperature can be approximately 120° C.

The heated water at the first temperature T1 enters the first stage 1 via the first pipe portion P1, where heat is transferred from the heated water to the heater 205 in the recess 203 that is in thermal communication with the first pipe portion P1 (as shown in, for example, in FIG. 5). The heater 205 is in direct contact with the adsorbent material 206 in the first stage 1 and effects the desorption of water therefrom as steam S1, which passes through a steam outlet SO of the stage (see e.g., FIG. 6). The heated water exits the first stage 1 at a second temperature T2 (lower than the first temperature T1), for example 100° C., via the first pipe portion P1 and continues to the second stage 2.

The heated water at the second temperature T2 enters the second stage 2 via a second pipe portion P2 and again effects the desorption of water from adsorbent material 206 in the second stage 2 as steam S2. The heated water exits the second stage via the second pipe portion P2 at a third temperature T3 (lower than the second temperature T2), for example 80° C., and passes through a condenser C1, where said heated water is heated to a fourth temperature T4 (greater than the third temperature T3) via heat generated by the condensation of the steam S1 (generated in the first stage 1) that also passes through the condenser C1.

The heated water at the fourth temperature T4 enters the third stage 3 via a third pipe portion P3 and again effects the desorption of water from adsorbent material 206 in the third stage 3 as steam S3. The heated water exits the third stage via the third pipe portion P3 at a fifth temperature T5 (lower than the fourth temperature T4), for example 60° C., and passes through a second condenser C2, where said heated water is heated to a sixth temperature T6 (greater than the fifth temperature T5) via heat generated by the condensation of the steam S2 (generated in the second stage 2), and via heat generated by the condensation of remaining steam S1 (generated in the first stage 1), where the steam S2 (and remaining steam S1) also passes through the second condenser C2.

The heated water at the sixth temperature T6 enters the fourth stage 4 via a fourth pipe portion P4 and again effects the desorption of water from adsorbent material 206 in the fourth stage 4 as steam S4. The heated water exits the fourth stage via the fourth pipe portion P4 at a seventh temperature T7 (lower than the sixth temperature T6), for example 40° C., and passes through a third condenser C3, where said heated water is heated to an eighth temperature T8 (greater than the seventh temperature T7) via heat generated by the condensation of the steam S3 (generated in the third stage 3), and via heat generated by the condensation of remaining steam S1 (generated in the first stage 1) and of remaining steam S2 (generated in the second stage 2), where the steam S3 (and remaining steam S2 and remaining steam S1) also passes through the third condenser C3. The condensed water exits the third condenser C3 and into the receptacle 230 and the heated water is directed to and passes through a pump P.

The heated water at the eighth temperature T8 enters the sixth stage 6 via a fifth pipe portion P5 and receives heat from the adsorbent material 206 (via conduction heat transfer via the heater 205) to recover sensible heat from the adsorbent material 206 in the sixth stage 6 (thereby cooling the adsorbent material 206). The heated water exits the sixth stage via the fifth pipe portion P5 at a ninth temperature T9 (greater than the eighth temperature T8).

The heated water at the ninth temperature T9 enters the seventh stage 7 via a sixth pipe portion 6 and receives heat from the adsorbent material 206 (via conduction heat transfer via the heater 205) to recover sensible heat from the adsorbent material 206 in the seventh stage 7 (thereby cooling the adsorbent material 206). The heated water exits the seventh stage via the sixth pipe portion P6 at a tenth temperature T10 (greater than the ninth temperature T9).

The heated water at the tenth 10 temperature 10 enters the eighth stage 8 via a seventh pipe portion 7 and receives heat from the adsorbent material 206 (via conduction heat transfer via the heater 205) to recover sensible heat from the adsorbent material 206 in the eighth stage 8 (thereby cooling the adsorbent material 206). The heated water exits the eighth stage via the seventh pipe portion P7 at an eleventh temperature T11 (greater than the tenth temperature T10), for example at approximately 80° C. The heated water exits the seventh pipe portion P7 at the eleventh temperature T11 and flows through the return pipe 240B to the heating location (e.g., receiver 132), where it can be heated to the first temperature T1 (greater than the eleventh temperature T1) and again directed to the first state 1 via the outflow pipe 240A.

Accordingly, the system 200 is operated to create a temperature differential between different stages 201 (e.g., first stage 1 to fourth stage 4) so that each of the stages (e.g., first stage 1 to fourth stage 4) operates at a different temperature and steam (S1, S2, S3) condenses at different temperatures, where the (latent) heat of condensation of steam generated in one stage is used to preheat or heat the adsorbent material 206 in a previous stage (e.g., via heating of the heated water flowing though the pipe portion in the stage). Such a multistage system results in increased efficiency in the desorption (stages 1-4) and sensible heat recuperation (stages 5-8) process.

With continued reference to FIG. 3, the adsorbent material 206 in the fifth stage 5 is at its lowest temperature (e.g., ambient temperature) and saturated with water. Once said adsorbent material 206 is moved to the fourth stage 4 (e.g., by rotating the rotor 202B counterclockwise), it receives heat from heated water flowing through the fourth pipe portion P4. Once said adsorbent material 206 is moved to the third stage 3 (e.g., by rotating the rotor 202B counterclockwise), it receives additional heat from the heated water flowing through the third pipe portion P4 at a higher temperature and a portion of its stored water is desorbed as steam S3. Once said adsorbent material 206 is moved to the second stage 2 (e.g., by rotating the rotor 202B counterclockwise), it receives additional heat from heated water flowing through the second pipe portion P2 at an even higher temperature and another portion of its stored water is desorbed as steam S2. Once said adsorbent material 206 is moved to the first stage 1 (e.g., by rotating the rotor 202B counterclockwise), it receives additional heat from heated water flowing through the first pipe portion P1 at an even higher temperature and another portion (e.g., the remaining portion) of its stored water is desorbed as steam S1.

FIGS. 7-11 show a system 300 for atmospheric water generation having multiple heat exchange modules 301 (e.g., arranged circumferentially about an axis). In the illustrated implementation, the system 300 has eleven heat exchange modules 301. However, the system 300 can have more or fewer heat exchange modules than shown (e.g., 2, 3, 5, 10, 15, etc.). In the illustrated implementation, the heat exchange modules 301 are stationary (e.g., do not move).

With reference to FIG. 7, each heat exchange module 301 has a container 302 with a heat exchanger 303 inside the container 302. The heat exchanger 303 can be a tube and fin heat exchanger. An adsorbent material 306 (e.g., desiccant material), such as silica gel, can fill at least a portion of the container 302 and be in contact (e.g., direct contact) with the heat exchanger 303, with an upper portion 304 of the container 302 remaining unfilled or defining an open space. In one implementation, the adsorbent material 306 is disposed between the tubes and fins of the heat exchanger 303. In another implementation, the heat exchanger 303 can be a desiccant coated heat exchanger. Though not shown, the container 302 can be selectively covered with a cover that seals the steam seal surface 305 of the container 302. Each heat exchange module 301 has a water inlet WI and a water outlet WO via which heated water flows through the tube(s) of the heat exchanger 303, as described below. Each heat exchange module 301 also has a steam exit opening SO via which steam generated in the container 302 exits the container 302. In one implementation, each steam exit opening SO can have a variable valve selectively actuatable to control the amount of steam released from its associated heat exchange module 301, allowing the heat exchange modules 301 to operate at different pressures. In another implementation, pressure can be varied by opening and closing covers over the heat exchange modules 301.

FIGS. 8-9 show a perspective view and a top view, respectively, of a manifold 310 of the system 300, about which the multiple heat exchange modules 301 are arranged. The manifold 310 can rotate (e.g., be rotated by an electric motor) relative to the multiple heat exchange modules 301 and operates as a rotary valve to selectively connect to one or more (e.g., 2, 3, 4, etc.) heat exchange modules 301 at the same time. The manifold 310 includes apertures 340A, 340B via which heated water enters the manifold 310 (e.g., from an outflow pipe and return pipe similar to 240A, 240B that extend to a receiver 132 where water flowing through the pipe is heated). Once in the manifold 310, the heated water is directed through the water inlet and outlet WI, WO of the heat exchange module(s) 301 via the water distribution section 313 of the manifold 310 for the heat exchange module(s) 301 that are fluidly connected to the manifold 310 so that heated water flows through the connected heat exchange module(s) in a sequential manner, so that each heat exchange module 301 generates steam S at different temperatures. The steam S exists the heat exchange module(s) 301 via their respective steam exit SO and into a respective opening on the steam inlet portion 312 of the manifold 310. Each steam inlet opening 312 is in fluid communication with an associated steam outlet opening 314.

With reference to FIGS. 9-11, the steam is directed to a condenser unit C at the center of the manifold 310, with insulating material 315 between the condenser unit C and an inner wall of the manifold 310. The condenser unit C can be a multilevel condenser unit with a first condenser C1, a second condenser C2 and a third condenser C3. The steam outlet openings 314 are located at different heights to direct the steam generated in a particular heat exchange module 301 to a particular condenser of the condenser unit C. For example, the steam at the highest temperature is directed over the first condenser C1, steam at a lower temperature is directed over the second condenser C2, and steam at an even lower temperature is directed over the third condenser C3.

Advantageously, the manifold 310 routes water through the heat exchange modules 301 to effect a similar multistage desorption process described above in connection with the system 200. That is, steam is generated at different temperatures, water flows through the heat exchanger 303 of different heat exchange modules 301 at different temperatures, and latent heat of condensation is recaptured to preheat or heat water flowing into another heat exchange module 301. As shown in FIG. 8, the manifold 310 can include O-rings 311 to separate the steam inlet section 312 from the water distribution section 313, and from the steam outlet section 314.

As the manifold 310 rotates, each heat exchange module 301 operates at different temperatures (e.g., based on the temperature of the water flowing through its associated heat exchanger 303). Each heat exchange module 301 (as the manifold 310 rotates) operates at different desorption stages and a different sensible heat recovery stage, similar to those described above for FIG. 2.

With reference to FIG. 10, the system 300 includes a blower B with a fan F. In one implementation, a cover (not shown) can selectively cover all but one of the heat exchange modules 301 and the blower B can blow air into the container 302 for said uncovered heat exchange module 301 to saturate the adsorbent material 306 with water. In another implementation. All heat exchange modules 301 can be covered on top and bottom, and an outer radial surface of a cylinder housing that surrounds the heat exchange modules 301 can have an opening that selectively changes position (e.g., rotates) to align with an exposed radial outer portion of one heat exchange module 301 and the blower B aligned with said opening can blow air into said heat exchange module 301 to saturate the adsorbent material 306 with water.

FIG. 12 shows a system 400 for atmospheric water generation. The system 400 is a two-stage system with a first stage G1 and a second stage G2, each stage operable to generate steam at a different temperature.

The first stage G1 includes a container 402 that houses an adsorbent material 406. As discussed above, the adsorbent material can be a solid material (e.g., a desiccant material, silica gel, a molecular sieve such as Zeolite, aluminum phosphate or a metal-organic framework) or a liquid material (e.g., lithium bromide, lithium chloride, calcium chloride, glycols, etc.). A heater 405 can extend into the container 402 and be in thermal contact (e.g., in direct contact) with the adsorbent material 406 so that heat is transferred between the heater 405 and the adsorbent material 406 via conduction heat transfer. For example, the heater 405 can be submerged in the adsorbent material 406 in the container 402. The heater 405 can optionally be a tube and fin heater. Optionally, the heater 405 can have a serpentine shape, as shown. In the illustrated example, the heater 405 can be part of a first fluid loop P1 (e.g., a tube or pipe loop) via which a heated liquid (e.g., heated water) is circulated (e.g., to and from a tank T1, by a pump). Such heated liquid in the tank T1 can, in one example, be at a temperature of approximately 160° C. Said liquid in the tank T1 can be circulated (by a pump) via a second fluid loop P2 (e.g., a tube or pipe loop) to a heat source (e.g., a receiver 132) that heats the liquid and returns the heated liquid to the tank T1. Optionally, a thermal energy storage tank TES can be in fluid communication with the second fluid loop P2 and can optionally store thermal energy (e.g., excess thermal energy) provided by the heat source to the liquid flowing through the second fluid loop P2. The liquid in the tank T1 and first and second fluid loops P1, P2 can be pressurized. In one example, the liquid in the tank T1 and second fluid loops P1, P2 can be at a pressure of about 6 bar.

The adsorption process for the adsorbent material 406 in the container 402 operates in a similar manner to that described above for FIG. 1. Though not shown, airflow can be directed (e.g., by a fan) through the adsorbent material 406 so that water condenses from the airflow onto the adsorbent material 406. In the desorption process, the adsorbent material 406 is heated by the heater 405 to desorb water from the adsorbent material 406 as steam S1 (at a relatively higher temperature) that exits the container 402. Said steam S1 flows to a condenser C1 where the steam condenses and the condensed liquid is directed to a storage tank 450 (e.g., of fresh water) where it is collected. At least a portion of the heat of condensation from condensing the steam S1 is recovered and used in the second stage G2, as discussed below.

The second stage G2 includes a container 402′ that houses an adsorbent material 406′. As discussed above, the adsorbent material can be a solid material (e.g., a desiccant material, silica gel, a molecular sieve such as Zeolite, aluminum phosphate or a metal-organic framework) or a liquid material (e.g., lithium bromide, lithium chloride, calcium chloride, glycols, etc.). In one example, the adsorbent material 406′ can be under vacuum (e.g., a vacuum force is applied to the adsorbent material 406′), which can advantageously help the adsorbent material absorb better the water that condenses on it from the airflow and/or facilitate (e.g., assist) the desorption process the second stage G2 and/or lower the desorption temperature to facilitate recovering at least a portion of the heat of condensation when condensing the steam for the second stage G2. A heater 405′ can extend into the container 402′ and be in thermal contact (e.g., in direct contact) with the adsorbent material 406′ so that heat is transferred between the heater 405′ and the adsorbent material 406′ via conduction heat transfer. For example, the heater 405′ can be submerged in the adsorbent material 406′ in the container 402′. The heater 405′ can optionally be a tube and fin heater. Optionally, the heater 405′ can have a serpentine shape, as shown. In the illustrated example, the heater 405′ can be part of a third fluid loop P3 (e.g., a tube or pipe loop) via which a heated liquid (e.g., heated water) is circulated (e.g., to and from a second tank T2, by a pump). Such heated liquid in the second tank T2 can, in one example, be at a temperature of approximately 99° C. A fourth fluid loop P4 can extend from the tank T1 to inside the second tank T2 to circulate heated liquid through the second tank T2 to heat the liquid in the second tank T2. The liquid in the second tank T2 and the third fluid loop P3 can be at atmospheric pressure. In one example, the liquid in the second tank T2 and third fluid loop P3 can be at a pressure of about 1 bar.

The adsorption process for the adsorbent material 406 in the container 402 operates in a similar manner to that described above for FIG. 1. Though not shown, airflow can be directed (e.g., by a fan) through the adsorbent material 406′ so that water condenses from the airflow onto the adsorbent material 406′. In the desorption process, the adsorbent material 406′ is heated by the heater 405′ to desorb water from the adsorbent material 406′. At least a portion of the heat of condensation from condensing the steam S1 with the condenser C1 is recovered and used to preheat the heated liquid flowing through the third fluid loop P3 before it enters the heater 405′ to heat the adsorbent material 406′. The heater 405′ desorbs water from the adsorbent material 406′ as steam S2 (at a relatively lower temperature than the steam S1) that exits the container 402′. Said steam S2 flows to a condenser C2 where the steam S2 condenses and the condensed liquid is directed to a collector 430, which then feeds into the storage tank 450 (of fresh water).

With continued reference to FIG. 12, the system 400 also includes a cold-water loop with a third tank T3 holding a volume of water that flows through a fifth tube loop P5 between the third tank T3 and the second condenser C2. At least a portion of the heat of condensation from condensing the steam S2 is used to heat the liquid in the fifth tube loop P5. A sixth tube loop P6 can circulate water from the third tank T through a radiator R where said water is cooled (e.g., by flowing air with a fan F past the radiator). In one example, the water in the third tank T3 can be at a temperature of approximately 30° C.

FIG. 13 shows one example of a concentrated solar power (CSP) system that can be used with the receiver 132 disclosed herein (e.g., in the system 200, 400). The receiver 132 can be located on a roof of a building and exposed to sunlight (e.g., reflected sunlight) directed from below to a pipe in fluid communication with the return pipe 240B and the outflow pipe 240A (see FIG. 3) or with apertures 340A, 340B (scc FIGS. 7-10). In one implementation, the CSP system can include a heliostat field 120 with one or more heliostats 122 supported on shafts or frames 112. Each heliostat 122 can have a tracking controller 114 and an actuator 116 and a mirror 110. The mirrors 110 can reflect sunlight to a receiver 132 in a tower 130. The outflow pipe 240A and return pipe 240B can extend along the height of the tower 130 and to the pipe at the top of the tower 130 that receives heat via the receiver to heat water flowing through said pipe. However, any type of CSP system can be used. In other implementations, a parabolic or Fresnel CSP system to heat the water (e.g., in fluid communication with the return pipe 240B and the outflow pipe 240A of FIG. 3 or with apertures 340A, 340B in FIGS. 7-10). In still another implementation a solar heater can be used to heat the water (e.g., in fluid communication with the return pipe 240B and the outflow pipe 240A of FIG. 3 or with apertures 340A, 340B in FIGS. 7-10).

The atmospheric water generation systems 100, 200, 300 described herein are more efficient than existing systems and have various advantages over existing systems. One advantage is that the atmospheric water generation systems 100, 200, 300 use heat, not electricity to generate water; electricity is used only for the blower, operation of any valve and motor for rotating the rotor 202B or manifold 310. Another advantage is that atmospheric water generation systems 100, 200, 300 use less heat than existing systems. Still another advantage is that the atmospheric water generation systems 100, 200, 300 recover sensible heat from the adsorbent material and heat exchangers and also recover latent heat of condensation, making these systems much more efficient. The systems 100, 200, 300 can achieve a reduction in the heat needed to evaporate water below the normally required 667 W-h/L (e.g., by at least ⅓^{rd}, such as by ½). The systems 100, 200, 300 also advantageously have lower capital expenditure costs than existing systems.

### Additional Embodiments

In embodiments of the present disclosure, a system and method for atmospheric water generation may be in accordance with any of the following clauses:

Clause 1: An atmospheric water generation system, comprising:
a volume of adsorbent material configured to receive airflow therethrough in an adsorption mode of operation, the adsorbent material configured to capture water in the airflow that condenses on the adsorbent material;
a heater in thermal contact with the adsorbent material and configured to heat the adsorbent material via conduction heat transfer in a desorption mode of operation to effect a desorption of moisture from the adsorbent material as steam; and
a condenser that receives and condenses the steam into liquid water,
wherein heat is released by the condensation of the steam, at least a portion of said heat being recovered and directed to the heater.

Clause 2: The system of clause 1, further comprising a collector configured to collect the liquid water.

Clause 3: The system of any preceding clause, wherein the adsorbent material is a solid material.

Clause 4: The system of clause 3, wherein the adsorbent material comprises a material chosen from the group consisting of silica gel, a molecular sieve such as Zeolite, aluminum phosphate and a metal-organic framework.

Clause 5: The system of clause 3, wherein the adsorbent material comprises a desiccant material.

Clause 6: The system of any of clauses 1-2, wherein the adsorbent material is a liquid material.

Clause 7: The system of clause 6, wherein the adsorbent material comprises a material chosen from the group consisting of lithium bromide, lithium chloride, calcium chloride, and glycols.

Clause 8: The system of any preceding clause, wherein said heat is recovered and directed to the heater via a pipe.

Clause 9: The system of clause 8, wherein said heat is recovered and directed to the heater via a liquid flowing through the pipe between the heater and the condenser.

Clause 10: The system of any preceding clause, wherein the heater comprises a fin and tube heat exchanger with a liquid flowing through the tube.

Clause 11: The system of clause 10, wherein the liquid flowing through the tube is heated by a receiver in a concentrated solar power plant.

Clause 12: The system of clause 10, wherein the liquid flowing through the tube is heated by the adsorbent material in a sensible heat recovery stage.

Clause 13: The system of any preceding clause, wherein the heater is a plurality of heaters housed in recesses of a stator circumferentially arranged about an axis of the stator.

Clause 14: The system of clause 13, wherein the volume of adsorbent material is a plurality of volumes of adsorbent material disposed in recesses circumferentially arranged about an axis of a rotor, the rotor being rotatably coupled to the stator about their respective axes, the rotor configured to rotate relative to the stator to place one heater in thermal contact with one volume of adsorbent material, said one heater and said one volume of adsorbent material providing a module.

Clause 15: The system of clause 14, wherein the plurality of heaters and the plurality of volumes of adsorbent material provide multiple modules, each module being operable to generate steam at a different temperature.

Clause 16: The system of clause 14, further comprising an electric motor operable to rotate the rotor relative to the stator.

Clause 17: The system of any of clauses 1-12, wherein the heater is a plurality of heaters housed in a plurality of separate containers along with a volume of adsorbent material to provide a multi-stage system with a plurality of heat exchange modules, each stage configured to generate steam at a different temperature.

Clause 18: The system of clause 17, wherein the multi-stage system is a two-stage system with two heat exchange modules, at least a portion of heat generated from condensing steam in one stage is recovered and used to preheat a liquid flowing into the heater in another stage.

Clause 19: The system of clause 17, wherein the adsorbent material in one or more of the plurality of separate containers of the heat exchange modules is under vacuum pressure.

Clause 20: The system of clause 17, wherein the adsorbent material in two or more of the plurality of separate containers of the heat exchange modules is under a different amount of vacuum pressure.

Clause 21: The system of clause 17, wherein the containers are circumferentially arranged about an axis.

Clause 22: The system of clause 21, further comprising a manifold about which the plurality of heat exchange modules is arranged.

Clause 23: The system of clause 22, wherein the manifold is rotatable about the axis to selectively place apertures of the manifold in fluid communication with a water inlet, a water outlet and a steam exit opening of one or more of the heat exchange modules.

Clause 24: The system of clause 22, wherein the condenser is housed in a center of the manifold.

Clause 25: The system of clause 24, wherein the condense is a multilevel condenser.

Clause 26: A method of generating atmospheric water, comprising:
flowing air through an adsorbent material in an adsorption stage so that water condenses from the air onto the adsorbent material;
heating the adsorbent material with a heater via conduction heat transfer in a desorption stage to desorb the water from the adsorbent material as steam;
flowing the steam to a condenser configured to condense the steam into liquid water; and
recovering at least a portion of heat released by the condensation of the steam and directing said recovered heat to the heater.

Clause 27: The method of clause 26, further comprising collecting the liquid water.

Clause 28: The method of any of clauses 26-27, wherein the adsorbent material is a solid material.

Clause 29: The method of clause 28, wherein the adsorbent material comprises a material chosen from the group consisting of silica gel, a molecular sieve such as Zeolite, aluminum phosphate and a metal-organic framework.

Clause 30: The method of clause 28, wherein the adsorbent material comprises a desiccant material.

Clause 31: The method of any of clauses 26-27, wherein the adsorbent material is a liquid material.

Clause 32: The method of clause 31, wherein the adsorbent material comprises a material chosen from the group consisting of lithium bromide, lithium chloride, calcium chloride, and glycols.

Clause 33: The method of any of clauses 26-32, wherein recovering said heat includes directing said heat to the heater via a pipe.

Clause 34: The method of clause 33, wherein directing said heat to the heater via a pipe includes flowing a liquid along the pipe.

Clause 35: The method of clause 34, wherein flowing the liquid along the pipe includes heating the liquid with a receiver in a concentrated solar power plant.

Clause 36: The method of clause 34, wherein flowing the liquid along the pipe includes heating the liquid with the adsorbent material in a sensible heat recovery stage.

Clause 37: The method of any of clauses 26-36, wherein heating the adsorbent material with the heater in the desorption stage to desorb the water as steam includes heating a plurality of separate volumes of adsorbent material with a plurality of heaters in multiple stages, each stage configured to generate steam at a different temperature.

Clause 38: The method of clause 37, wherein the multiple stages are two stages.

Clause 39: The system of clause 37, wherein one or more of the plurality of separate volumes of adsorbent material is under vacuum pressure.

Clause 40: The system of clause 39, wherein two or more of the plurality of separate volumes of adsorbent material is under a different amount of vacuum pressure.

Clause 41: The method of clause 37, wherein at least a portion of heat generated by condensing steam generated in one stage is recovered and used to preheat a liquid flowing into the heater in another stage.

Clause 42: The method of clause 37, further comprising rotating the plurality of separate volumes of adsorbent material relative to the plurality of heaters.

Clause 43: An atmospheric water generation system, comprising:
multiple heat exchange modules, each heat exchange module comprising
   a container housing a tube and fin heat exchanger,
   a volume of adsorbent material in thermal contact with the tube and fin
heat exchanger,
   a water inlet in fluid communication with one end of the tube,
   a water outlet in fluid communication with another end of the tube, and
   a steam outlet;
a rotatable manifold about which the multiple heat exchange modules are arranged, the rotatable manifold configured to route heated water through the heat exchange modules to generate steam at different temperatures via desorption of water from the adsorbent material;
a condenser configured to condense said steam generated at the different temperatures into liquid water,
wherein heat from condensing steam generated in one heat exchange module is recovered and directed to another heat exchange module to heat water flowing into the water inlet of another heat exchange module.

Clause 44: The system of clause 43, further comprising a collector configured to collect the liquid water.

Clause 45: The system of clause 43, wherein the adsorbent material is silica gel.

Clause 46: The system of clause 43, wherein said heat is recovered and directed to said another heat exchange module via a pipe.

Clause 47: The system of clause 43, wherein the heated water is heated by a receiver in a concentrated solar power plant.

Clause 48: The system of clause 43, wherein the condenser is housed in a center of the manifold.

Clause 49: The system of clause 48, wherein the condenser is a multilevel condenser.

Clause 50: An atmospheric water generation system, comprising:
a stator comprising a plurality of recesses circumferentially arranged about an axis, the plurality of recesses housing a plurality of heaters;
a rotor comprising a plurality of recesses circumferentially arranged about a second axis, the plurality of recesses of the rotor housing a plurality of volumes of adsorbent material, the rotor configured to rotatably couple to the stator and configured to rotate relative to the stator about the second axis to place one heater in thermal contact with one volume of adsorbent material to heat said one volume of adsorbent material via conduction heat transfer to desorb water from the adsorbent material as steam, said plurality of heaters and said plurality of volumes of adsorbent material providing multiple modules, each module operable to generate steam at a different temperature; and
a condenser configured to condense said steam generated at the different temperatures into liquid water.
wherein heat from condensing steam generated in one module is recovered and directed to a heater in another module to heat water flowing into said heater of another module.

Clause 51: The system of clause 50, wherein each of the heaters is a tube and fin heat exchanger, the tube configured to receive heated water therethrough.

Clause 52: The system of clause 50, wherein the adsorbent material is silica gel.

Clause 53: The system of clause 50, wherein said heat is recovered and directed to said heater in another module via a pipe.

Clause 54: The system of clause 51, wherein the heated water is heated by a receiver in a concentrated solar power plant.

Clause 55: The system of clause 50, wherein the condenser is a multilevel condenser.

While certain embodiments of the inventions have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

1. An atmospheric water generation system, comprising:
a volume of adsorbent material configured to receive airflow therethrough in an adsorption mode of operation, the adsorbent material configured to capture water in the airflow that condenses on the adsorbent material;
a heater in thermal contact with the adsorbent material and configured to heat the adsorbent material via conduction heat transfer in a desorption mode of operation to effect a desorption of moisture from the adsorbent material as steam; and
a condenser that receives and condenses the steam into liquid water,
wherein heat is released by the condensation of the steam, at least a portion of said heat being recovered and directed to the heater.

2. (canceled)

3. (canceled)

4. (canceled)

5. The system of claim 1, wherein the adsorbent material comprises a desiccant material.

6. (canceled)

7. (canceled)

8. The system of claim 1, wherein said heat is recovered and directed to the heater via a pipe.

9. The system of claim 8, wherein said heat is recovered and directed to the heater via a liquid flowing through the pipe between the heater and the condenser.

10. The system of claim 1, wherein the heater comprises a fin and tube heat exchanger with a liquid flowing through the tube.

11. The system of claim 10, wherein the liquid flowing through the tube is heated by a receiver in a concentrated solar power plant.

12. The system of claim 10, wherein the liquid flowing through the tube is heated by the adsorbent material in a sensible heat recovery stage.

13. The system of claim 1, wherein the heater is a plurality of heaters housed in recesses of a stator circumferentially arranged about an axis of the stator.

14. The system of claim 13, wherein the volume of adsorbent material is a plurality of volumes of adsorbent material disposed in recesses circumferentially arranged about an axis of a rotor, the rotor being rotatably coupled to the stator about their respective axes, the rotor configured to rotate relative to the stator to place one heater in thermal contact with one volume of adsorbent material, said one heater and said one volume of adsorbent material providing a module.

15. The system of claim 14, wherein the plurality of heaters and the plurality of volumes of adsorbent material provide multiple modules, each module being operable to generate steam at a different temperature.

16. The system of claim 14, further comprising an electric motor operable to rotate the rotor relative to the stator.

17. The system of claim 1, wherein the heater is a plurality of heaters housed in a plurality of separate containers along with a volume of adsorbent material to provide a multi-stage system with a plurality of heat exchange modules, each stage configured to generate steam at a different temperature.

18. The system of claim 17, wherein the multi-stage system is a two-stage system with two heat exchange modules, at least a portion of heat generated from condensing steam in one stage is recovered and used to preheat a liquid flowing into the heater in another stage.

19. The system of claim 17, wherein the adsorbent material in one or more of the plurality of separate containers of the heat exchange modules is under vacuum pressure.

20. The system of claim 17, wherein the adsorbent material in two or more of the plurality of separate containers of the heat exchange modules is under a different amount of vacuum pressure.

21. The system of claim 17, wherein the containers are circumferentially arranged about an axis.

22. The system of claim 21, further comprising a manifold about which the plurality of heat exchange modules is arranged.

23. The system of claim 22, wherein the manifold is rotatable about the axis to selectively place apertures of the manifold in fluid communication with a water inlet, a water outlet and a steam exit opening of one or more of the heat exchange modules.

24. The system of claim 22, wherein the condenser is housed in a center of the manifold.

25. The system of claim 24, wherein the condense is a multilevel condenser.

26-55. (canceled)
